(19) United States
(12) Patent Application Publication
(10) Pub. No.: US 2026/0155412 A1
(43) Pub. Date: Jun. 4, 2026

(54) SYSTEM AND METHOD FOR CONTROLLING VOLTAGE OF FUEL CELL

(71) Applicants: Hyundai Motor Company, Seoul (KR); Kia Corporation, Seoul (KR)

(72) Inventors: Seung Won BAIK, Hwaseong-Si (KR); Young Pin JIN, Hwaseong-Si (KR); Jong Bin KANG, Hwaseong-Si (KR)

(21) Appl. No.: 19/187,074

(22) Filed: Apr. 23, 2025

(30) Foreign Application Priority Data
Nov. 29, 2024 (KR) 10-2024-0174437

(51) Int. Cl. H01M 8/04992; B60L 58/32; H01M 8/0432; H01M 8/0438; H01M 8/0444; H01M 8/04492; H01M 8/04858

(52) U.S. Cl. CPC H01M 8/04992; B60L 58/32; H01M 8/04358; H01M 8/0438; H01M 8/04455; H01M 8/04492; H01M 8/04865; H01M 2250/20

(57) ABSTRACT

A system of a vehicle is introduced. The system may comprise memory storing at least one instruction, and a processor configured to execute the at least one instruction and cause the system to control, based on an operating environment of the vehicle and a state of the fuel cell, a voltage of the fuel cell. The processor may be configured to control the voltage of the fuel cell by determining a correction factor for performing correction on an initial voltage value of the fuel cell, and calculating a voltage value for controlling the fuel cell by performing feedback control. The feedback control may adjust the corrected voltage value using an output error, the output error being a difference between an actual output and a requested output.

### CROSS-REFERENCE TO RELATED APPLICATION

This application claims under 35 U.S.C. § 119 (a) the benefit of priority to Korean Patent Application No. 10-2024-0174437, filed in the Korean Intellectual Property Office on Nov. 29, 2024, the entire contents of which are incorporated herein by reference.

### TECHNICAL FIELD

The present disclosure relates to a system and method for controlling a voltage of a fuel cell capable of performing optimized voltage control of the fuel cell in consideration of a driving environment of a vehicle and a state of the fuel cell.

### BACKGROUND

The information disclosed in this Background section is only for enhancement of understanding of the background of the disclosure and contains information that does not form the prior art that is already known in this country to a person of ordinary skill in the art.

An environmentally friendly vehicle equipped with a fuel cell controls a voltage of a fuel cell and performs voltage control of a converter to respond to requested output of a driver. A fuel cell converter for controlling a high-voltage battery mounted in the environmentally friendly vehicle and a Bidirectional High Voltage DC Converter (BHDC) for controlling the fuel cell may be applied to the environmentally friendly vehicle. The voltage control of the converter may be performed to output actual output corresponding to requested output of the driver, and the fuel cell has a different appropriate potential value at the same current depending on the outside temperature, relative humidity of the fuel cell, driving time, atmospheric pressure, deterioration, etc. The BHDC may be controlled through Feed Forward (FF) control and Feed Backward (FB) control. FF control may be performed using an initial voltage value corresponding to the requested output, and in FB control, a voltage adjustment amount may be determined using a fixed coefficient corresponding to the requested output and an initial voltage value is added thereto to determine a final voltage value.

However, BHDC control may not select an initial voltage suitable for an operating environment of the fuel cell, but may simply use a preset table value corresponding to the requested output, and thus may not conform to potential fluctuation that occurs depending on the operating environment. Since an appropriate or desirable potential of the fuel cell fluctuates according to the requested current depending on various factors (e.g., a fuel cell operation maintenance time, humidity, coolant temperature, and altitude), when these factors are not considered, a fuel cell performance curve may be distorted. In addition, as the operating time of the fuel cell increases, the voltage adjustment amount may become excessive, which may cause multiplication of a V-I performance curve.

### SUMMARY

The present disclosure has been made in an effort to solve the above-described problems.

According to the present disclosure, a system of a vehicle, the system may comprise memory storing at least one instruction, and a processor configured to execute the at least one instruction and cause the system to control, based on an operating environment of the vehicle and a state of the fuel cell, a voltage of the fuel cell, wherein the processor is configured to control the voltage of the fuel cell by determining a correction factor for performing correction on an initial voltage value of the fuel cell, and calculating a voltage value for controlling the fuel cell by performing feedback control, wherein the feedback control adjusts the corrected voltage value using an output error, the output error being a difference between an actual output and a requested output.

The operating environment of the vehicle may comprise at least one of operation duration of the fuel cell, an outside temperature, or an atmospheric pressure, and the state of the fuel cell may comprise at least one of a coolant temperature of the fuel cell, a stoichiometric ratio (SR) of air supplied to a cathode of the fuel cell, or relative humidity of the fuel cell, wherein the SR of air corresponds to a ratio of an actual amount of air supplied to the cathode relative to a minimum amount of air required for the fuel cell.

The correction factor is determined based on at least one of the outside temperature, an atmospheric pressure, the coolant temperature of the fuel cell, the SR, or the relative humidity of the fuel cell, and the corrected voltage value is determined as a product of a value and the correction factor, wherein the value is obtained by subtracting a voltage drop amount, according to the operation duration of the fuel cell, from the initial voltage value.

The initial voltage value is derived by a voltage map, wherein the voltage map is configured to store voltage values measured according to a plurality of requested outputs, and wherein the plurality of requested outputs are required for the fuel cell for driving the vehicle.

When the correction factor is greater than a first value, the processor is configured to increase a first-gain value for a first-type control and increase a second-gain value for a second-type control, and determine an intermediate voltage value by based on a sum of the corrected voltage value, a first product of the increased first-gain value and the output error, and a second product of the increased second-gain value and the output error.

When the correction factor is less than or equal to a preset first value, the processor is configured to compare the output error with a second value determined by the requested output, and control, based on one of a first type control or a second type control, a gain value.

The processor is configured to increase, based on the output error being greater than the second value, a first-gain value for the first type control, wherein the second value is obtained by multiplying the requested output by a preset first error value, and increase, based on the output error being less than or equal to the second value, a second-gain value for the second type control.

The processor is configured to determine an intermediate voltage value by iteratively adjusting the corrected voltage value, wherein each iteration may comprise determining a voltage adjustment amount based on a product of the output error and either the first-gain value or the second-gain value, and adding the voltage adjustment amount to an accumulated value, wherein the iterations continue until an absolute value of the accumulated value, accumulated over one or more iterations, exceeds a third value, wherein the third value is obtained by multiplying a voltage drop amount, according to an operation duration of the fuel cell, by a preset second error value.

Based on the absolute value of the accumulated value exceeding the third value, the processor is configured to determine a final voltage value by applying the third value to the intermediate voltage value.

Based on the accumulated value being a positive value, the processor is configured to determine the final voltage value by subtracting the third value from the intermediate voltage value, and based on the accumulated value being a negative value, the processor is configured to determine the final voltage value by adding the third value to the intermediate voltage value.

The system may comprise a processor configured to determine an intermediate voltage value by, based on a result of comparing the correction factor with a preset first value, simultaneously performing a first type control and a second type control on the corrected voltage value, or sequentially performing the first type control and the second type control on the corrected voltage value.

Based on an absolute value of an accumulated value, accumulated by updating the corrected voltage value according to the second type control, exceeding a third value, the processor is configured to determine a final voltage value by modifying the intermediate voltage value, wherein the intermediate voltage value is updated based on the first type control and the second type control, and wherein the intermediate voltage value is modified by subtracting or adding the absolute value of the accumulated value or the third value from or to the intermediate voltage value.

According to the present disclosure, a method performed by a processor of a vehicle, the method may comprise determining, based on an operating environment of the vehicle and a state of a fuel cell of the vehicle, a correction factor for performing correction on an initial voltage value of the fuel cell, obtaining a product of the correction factor and the initial voltage value as a corrected voltage value, deriving a voltage value for controlling the fuel cell by performing feedback control, wherein the feedback control adjusts the corrected voltage value using an output error, wherein the output error is a difference between an actual output and a requested output, and controlling, based on the derived voltage value, an operation of the fuel cell.

The initial voltage value of the fuel cell is derived by a voltage map, wherein the voltage map is configured to store voltage values measured according to a plurality of requested outputs, and wherein the plurality of requested outputs are required for the fuel cell for driving the vehicle.

The operating environment of the vehicle may comprise at least one of operation duration of the fuel cell, an outside temperature, or an atmospheric pressure, the state of the fuel cell may comprise at least one of a coolant temperature of the fuel cell, an SR of air supplied to a cathode of the fuel cell, or relative humidity of the fuel cell, and the determining the correction factor may comprise determining the correction factor based on at least one of the outside temperature, the atmospheric pressure, the coolant temperature of the fuel cell, the SR of air, or the relative humidity of the fuel cell, wherein the corrected voltage value is determined as a product of a value and the correction factor, wherein the value is obtained by subtracting a voltage drop amount, according to the operation duration of the fuel cell, from the initial voltage value.

The deriving the voltage value may comprise comparing the correction factor with a preset first value, determining an intermediate voltage value by, based on the comparing, simultaneously performing a first type control and a second type control on the corrected voltage value or sequentially performing the first type control and the second type control on the corrected voltage value, and determining, based on an absolute value of an accumulated value exceeding a third value, a final voltage value by modifying the intermediate voltage value, wherein the intermediate voltage value is updated according to the first type control and the second type control, wherein the accumulated value is accumulated in the intermediate voltage value based on the second type control, and wherein the intermediate voltage value is modified by adding or subtracting the third value to or from the intermediate voltage value.

Based on the correction factor exceeding the preset first value, the intermediate voltage value is determined based on a sum of the corrected voltage value, a first product of a first-gain value for the first type control and the output error, and a second product of a second-gain value for the second type control and the output error.

Based on the correction factor being less than or equal to the preset first value, the intermediate voltage value is determined by comparing the output error with a second value determined by the requested output, and applying a gain value to the corrected voltage value, wherein the gain value is increased based on one of the first type control or the second type control.

The determining the intermediate voltage value is iteratively performed until an absolute value of the accumulated value, accumulated over one or more iterations, exceeds the third value, wherein the accumulated value is obtained by multiplying the output error by a second-gain value for the second type control, and wherein the third value is obtained by multiplying a voltage drop amount, according to an operation duration of the fuel cell, by a preset second error value.

The deriving the voltage value may comprise based on the accumulated value being a positive value, determining the final voltage value by subtracting the absolute value of the accumulated value or the third value from the intermediate voltage value, or based on the accumulated value being a negative value, determining the final voltage value by adding the absolute value of the accumulated value or the third value to the intermediate voltage value.

Other examples and preferred examples of the disclosure are discussed infra. The above and other features of the disclosure are discussed infra.

### BRIEF DESCRIPTION OF THE DRAWINGS

The above and other features of the present disclosure will now be described in detail with reference to certain examples thereof illustrated the accompanying drawings which are given hereinbelow by way of illustration only, and thus are not limitative of the present disclosure, and wherein:

FIG. 1 shows an example of a graph for describing multiplication of a V-I performance curve occurring during voltage control of a typical fuel cell;

FIG. 2 shows an example of a block diagram for describing a fuel cell voltage control system according to an example of the present disclosure;

FIG. 3 shows an example of a block diagram for describing a function of a processor according to an example of the present disclosure;

FIG. 4 shows an example of a flowchart for describing a method of calculating a correction factor according to an example of the present disclosure;

FIG. 5 shows an example of a flowchart for describing a method of calculating a final voltage value for voltage control of the fuel cell according to an example of the present disclosure; and

FIG. 6 shows an example of a graph for describing following one V-I performance curve when controlling a voltage of the fuel cell according to an example of the present disclosure.

### DETAILED DESCRIPTION

Advantages and features of the present disclosure, and a method of achieving the advantages and features will become apparent with reference to the examples described below in detail together with the accompanying drawings. However, the present disclosure is not limited to the examples disclosed below and may be implemented in various different forms, the present examples are provided only to ensure that the disclosure of the present disclosure is complete and to fully inform a person skilled in the art to which the present disclosure pertains of the scope of the disclosure, and the present disclosure is defined only by the scope of the claims. Like reference numerals refer to like elements throughout the specification.

The terms “ . . . section”, “ . . . unit”, “ . . . module”, etc., described in the specification mean a unit that processes at least one function or operation, which may be implemented by hardware (e.g., circuit, circuitry, or application-specific integrated circuits (ASICs)), software, or a combination of hardware and software.

In addition, names of components in this specification are divided into first, second, etc. to distinguish the components when the names of the components are the same, and the order in the description below is not necessarily limited to that order.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The detailed description is illustrative of the present disclosure. In addition, the above-described content illustrates and describes preferred examples of the present disclosure, and the present disclosure may be used in various other combinations, modifications, and environments. That is, changes or modifications are possible within the scope of the inventive concept disclosed in this specification, the scope equivalent to the described disclosure, and/or the scope of technology or knowledge in the art. The described examples are intended to best illustrate the technical idea of the present disclosure, and various modifications required for specific application fields and uses of the present disclosure are possible. Therefore, the detailed description of the present disclosure above is not intended to limit the present disclosure to the disclosed examples. In addition, the appended claims should be interpreted to include other examples.

According to the present disclosure, fuel cell vehicles may rely on precise voltage control to efficiently convert hydrogen into electricity. Voltage control methods using preset values to determine the initial voltage may fail to adapt to real-time environmental or operational conditions of a vehicle, for example, like temperature, humidity, and altitude, leading to voltage errors that accumulate over time. These errors may distort the fuel cell's performance curve (e.g., V-I curve), reducing efficiency and durability.

According to the present disclosure, an active voltage control system may dynamically adjust voltage based on environmental and operational factors. By integrating real-time feedback, the system may correct voltage discrepancies and prevents unnecessary voltage drops, thereby maintaining fuel cell stability, improving power efficiency, and extending system lifespan without requiring additional hardware like external DC-DC converters. This approach may ensure ideal or optimal energy use while reducing degradation, making fuel cell vehicles more reliable and efficient.

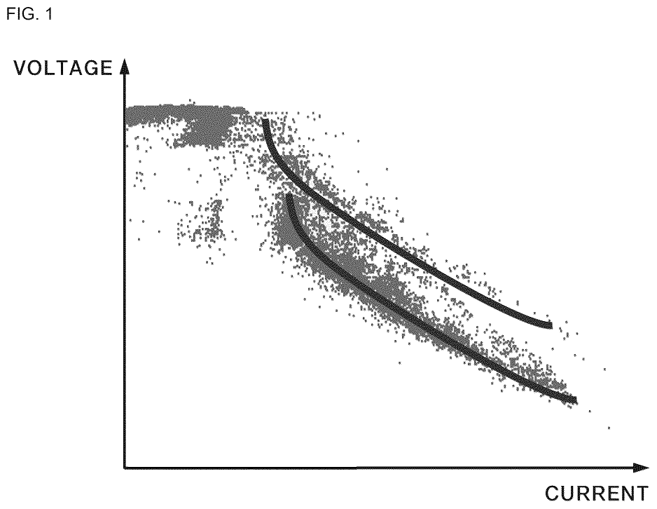

FIG. 1 shows an example of a graph for describing multiplication of a V-I performance curve occurring during voltage control of a typical fuel cell. Referring to FIG. 1, in a process of following output of the fuel cell, a voltage adjustment amount occurring according to feedback control is accumulated, and the accumulated voltage adjustment amount causes distortion of the fuel cell V-I performance curve. Accumulation of the voltage adjustment amount causes multiplication in which the fuel cell V-I performance curve divided into several branches, and an error of an initial voltage value of the fuel cell causes a wide voltage distribution at the same current.

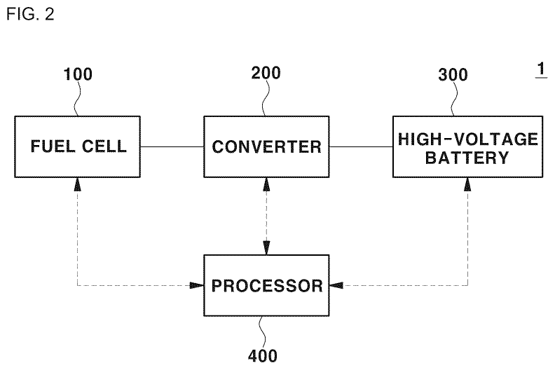

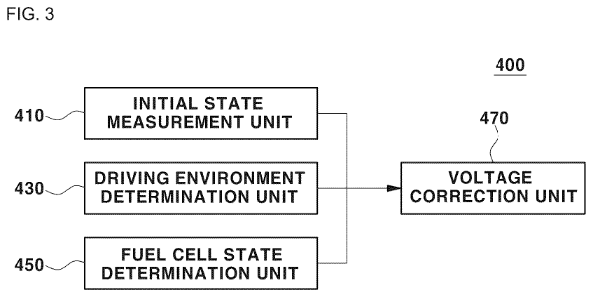

FIG. 2 shows an example of a block diagram for describing a fuel cell voltage control system according to an example of the present disclosure, and FIG. 3 shows an example of a block diagram for describing a function of a processor according to an example of the present disclosure.

Referring to FIG. 2 and FIG. 3, the fuel cell voltage control system 1 may include a fuel cell 100, a power converter (e.g., a converter 200), a high-voltage battery 300, and a processor 400. The fuel cell voltage control system 1 may control a voltage of the fuel cell 100 and control the converter 200 through the processor 400 to respond to a power demand (e.g., requested output) of a driver. The converter 200 is a power converter (e.g., a voltage management device) that controls energy transfer to or from the high-voltage battery 300 (e.g., power input to or output from the high-voltage battery 300), and may be a bidirectional power converter (e.g., BHDC (Bidirectional High voltage DC Converter)) that controls bidirectional movement of current. The converter 200 may be provided between the fuel cell 100 and the high-voltage battery 300 to control a voltage of the fuel cell 100. That is, the converter 200 may be configured to control both the fuel cell 100 and the high-voltage battery 300. The fuel cell voltage control system 1 may be a system applied to an environmentally friendly vehicle equipped with the fuel cell 100, such as a hydrogen-powered passenger vehicle, a commercial truck, or a stationary power system.

The processor 400 may include a fuel cell control unit (FCU) for controlling the fuel cell 100. The processor 400 may include a memory (e.g., RAM, flash memory, or SSD storage). The processor 400 may include one or more cores, and may include circuit, circuitry, or application-specific integrated circuits (ASICs) for data analysis and deep learning, such as a central processing unit (CPU), a general-purpose graphics processing unit (GP GPU), a tensor processing unit (TPU), and an application processor (AP) of a computing device. One or more processors 400 may perform a control operation to process input data according to a predefined operation rule or an artificial intelligence (AI) model stored in a memory. For example, the processor 400 may analyze voltage fluctuations, predict enhanced control parameters, or adjust power distribution dynamically based on real-time conditions. When the one or more processors 400 are AI-only processors, an AI-only processor may be designed to have a hardware structure specialized for processing a specific AI model, such as reinforcement learning-based energy enhancement or predictive maintenance algorithms.

The processor 400 may read a computer program or command stored in the memory to perform fuel cell voltage control according to the present example. The memory may store various information and maps required for fuel cell voltage control according to an example of the present disclosure. The memory may include at least one type of storage medium among a flash memory type, a hard disk type, a multimedia card micro type, a card type memory (for example, an SD or XD memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disc. In addition, the memory may include any form of a computer-readable recording medium well known in the art to which the present disclosure pertains. The above-described memory is merely an example, and the present disclosure is not limited thereto.

The processor 400 may determine or estimate an adjustment factor (e.g., a correction factor) for performing correction on an initial voltage value of the fuel cell, and calculate an intermediate voltage value and/or a final voltage value for following the requested output of the fuel cell through feedback control on an adjusted voltage value (e.g., a corrected voltage value) to which the correction factor is applied. For example, the correction factor may compensate for changes in fuel cell performance due to temperature variations, altitude differences, or humidity fluctuations, ensuring stable operation under diverse environmental conditions.

The processor 400 may include an initial state measurement unit 410, a driving environment determination unit 430, and a fuel cell state determination unit 450 for measuring and calculating a plurality of factors for calculating a correction factor.

The initial state measurement unit 410 may derive a voltage map that stores voltage values measured according to a plurality of requested outputs required for the fuel cell 100 when the vehicle is driven. The initial state measurement unit 410 may derive data on voltage and current according to the output required for the fuel cell. The initial state measurement unit 410 may derive a voltage map using data on voltage and current acquired under specific conditions. For example, the specific conditions may include steady-state driving on a highway, vehicle operation at different altitudes (e.g., sea level, high-altitude mountain roads), or temperature-controlled environments (e.g., cold-start scenarios in winter). For example, the specific conditions may mean that an altitude corresponds to a level land and the temperature of the fuel cell 100 or the coolant temperature of the fuel cell 100 converges to a preset target value. That is, the initial state measurement unit 410 may derive a voltage map using data on voltage and current acquired in an environment where the specific conditions are satisfied. The voltage map may be continuously updated by the initial state measurement unit 410. For example, the system may refine the voltage map over time by incorporating data from past driving cycles, learning from real-world conditions. For example, the voltage map may be updated based on the time when ignition of the vehicle is turned on/off. The voltage map may be stored in the memory or processor 400.

The driving environment determination unit 430 may calculate at least one factor for the driving environment in which the vehicle is being driven. The at least one factor may help adapt the fuel cell's voltage control strategy to match real-world conditions. For example, the driving environment may include at least one of the operation duration of the fuel cell 100, the outside temperature, and the atmospheric pressure. For example, additional environmental factors may include road grade (e.g., uphill, downhill, or flat terrain), humidity levels, and wind resistance, one or more of which may impact the vehicle's power demands and fuel cell efficiency. The outside temperature and the atmospheric pressure may be acquired from a separate sensor mounted in the vehicle, and the acquired information may be transmitted to the driving environment determination unit 430.

The fuel cell state determination unit 450 may calculate at least one factor for determining a driving state of the fuel cell 100. The at least one factors may lead to precise fuel cell performance adjustments to maintain efficiency and prevent premature degradation. For example, factors for determining the driving state of the state of the fuel cell 100 may include at least one of the coolant temperature of the fuel cell 100, a stoichiometric ratio (SR) of air supplied to a cathode of the fuel cell 100, or the relative humidity of the fuel cell 100. For example, additional factors may include hydrogen concentration levels, stack pressure, or internal resistance fluctuations due to fuel cell aging. The coolant temperature of the fuel cell 100 may be acquired by a separate sensor. The relative humidity of the fuel cell 100 may be determined or estimated by considering the temperature of the fuel cell 100 or the coolant temperature, the internal pressure of the fuel cell 100, the amount of generated water discharged from the fuel cell 100, or transient operating conditions such as sudden acceleration or regenerative braking, etc. The SR of the air supplied to the cathode of the fuel cell 100 may be determined according to the relative humidity of the fuel cell 100. The SR for the air supply may be a ratio of the amount of oxygen according to current corresponding to the requested output of the fuel cell 100 to the amount of oxygen supplied to the fuel cell 100 (e.g., SR=an amount of oxygen required/an amount of oxygen actually supplied to the fuel cell). In other words, increasing the SR for the air supply may mean indirectly increasing the amount of air supplied to the fuel cell 100. For example, under high power demand conditions (e.g., rapid acceleration), the system may momentarily increase the SR, while under low-power cruising conditions, it may reduce the SR to conserve energy.

A voltage correction unit 470 may determine an adjustment factor (e.g., a correction factor) based on data received from the initial state measurement unit 410, the driving environment determination unit 430, and the fuel cell state determination unit 450. This correction factor may allow real-time enhancement or optimization of fuel cell voltage, ensuring stable power delivery under changing environmental conditions. The correction factor may be determined or estimated by considering at least one of the outside temperature, the atmospheric pressure, the coolant temperature of the fuel cell 100, the SR, or the relative humidity of the fuel cell 100. For instance, during high-altitude driving, the correction factor may account for reduced oxygen levels, adjusting voltage to maintain fuel cell efficiency. Similarly, during prolonged idling, it may compensate for thermal losses to prevent unnecessary energy drain. The voltage correction unit 470 may calculate the corrected voltage value by multiplying a value obtained by subtracting a voltage drop amount according to the operation duration of the fuel cell 100 from the initial voltage value by the correction factor. The initial state measurement unit 410 may calculate the initial voltage value matching the voltage map according to the requested output required for the fuel cell 100. However, when the fuel cell 100 or the vehicle equipped with the fuel cell 100 is operated for the first time, the initial voltage value may be calculated based on a BOL (Beginning of Life) voltage according to the output of the fuel cell 100. For example, BOL values may differ for newly manufactured fuel cells versus those that have undergone factory preconditioning cycles. The voltage drop amount may be a value determined according to a predefined dataset (e.g., a table) stored in advance according to the output of the fuel cell 100 and the operation duration of the fuel cell 100. As an ON state of the fuel cell 100 is maintained, reversible deterioration of the fuel cell 100 progresses, and thus the voltage drop amount according to the operation duration of the fuel cell 100 may be used to determine or estimate the corrected voltage value.

The correction factor may be calculated according to the following formula.

$$Correction factor = ( 1 + α ) \times ( 1 + β ) \times ( 1 + γ ) \times δ \times ( 1 - \frac{1}{θ} )$$

In the above formula, α denotes a current coolant temperature relative to a target coolant temperature. β denotes a value obtained by subtracting a reference temperature from a current outside temperature and dividing a resultant value by 273. γ denotes a current atmospheric pressure relative to a target atmospheric pressure. δ denotes a current SR relative to a target SR. θ denotes current relative humidity relative to target relative humidity. For example, the reference temperature may be 20 degrees. The target coolant temperature and the target atmospheric pressure may be preset values. For example, the target coolant temperature may be approximately 60 degrees, and the target atmospheric pressure may be 1 atmosphere. The target SR and the target relative humidity may be values determined according to a predefined dataset (e.g., a pre-stored table) depending on the fuel cell stack (e.g., fuel cell stack age) or coolant temperature, the internal pressure of the fuel cell 100, and the amount of generated water discharged from the fuel cell 100.

The voltage of the fuel cell 100 decreases as the outside temperature decreases and the air becomes thinner. For example, high-altitude locations such as mountainous regions may experience reduced oxygen availability, requiring adjustments to maintain proper voltage levels. In order to follow a voltage decrease of the fuel cell 100, factors related to environmental conditions such as the outside temperature and the atmospheric pressure may be considered in a process of obtaining the correction factor. That is, when the outside temperature or the atmospheric pressure is low, the processor 400 may lower the voltage of the fuel cell 100 to match an appropriate potential, and may lower the voltage of the fuel cell 100 and increase the air supply at the same output to induce a temperature increase in the fuel cell 100. In addition, when the relative humidity of the fuel cell 100 is high, a factor related to the relative humidity may be considered in a process of obtaining a correction factor (e.g., to counteract excess moisture buildup) in order to follow a decrease in the voltage of the fuel cell 100 for an increase in the air supply. The processor 400 may determine that a flooding phenomenon of the fuel cell 100 has occurred when the relative humidity of the fuel cell 100 is high, and the processor 400 may prevent the flooding phenomenon by increasing the air supply due to the use of a high current at the same output as the voltage is lowered. For example, if excessive condensation is detected within the fuel cell stack, the processor may temporarily increase airflow to evaporate excess moisture while maintaining efficient operation. In addition, when the amount of air supplied to the fuel cell 100 is higher than a control value, a factor for the SR may be considered in the process of obtaining the correction factor to follow the increase in voltage of the fuel cell 100 due to air supercharging. That is, when the amount of air supplied is high, the processor 400 may reduce the air supply by increasing the voltage of the fuel cell 100 at the same output and lowering the current of the fuel cell 100. The correction factor may be calculated by applying factors for determining the driving environment of the vehicle and the state of the fuel cell. The processor 400 may induce an appropriate potential of the fuel cell 100 and reduce performance degradation in the fuel cell 100 or minimize additional deterioration factors of the fuel cell 100 by using a corrected voltage value obtained by applying the correction factor to the initial voltage value when controlling the voltage of the fuel cell 100.

The voltage correction unit 470 may perform feedback control using an output discrepancy (e.g., an output error), which is a difference between actual output of the fuel cell 100 and the requested output, to operate the fuel cell 100 at an appropriate potential, thereby calculating a voltage value for controlling the fuel cell 100. The voltage value for controlling the fuel cell 100 may include a plurality of voltage values (e.g., an intermediate voltage value and a final voltage value). The processor 400 may control the converter 200 based on the intermediate voltage value and the final voltage value determined or estimated as a result of the feedback control, and thus perform voltage control of the fuel cell 100 that may follow an ideal or enhanced V-I curve.

The voltage correction unit 470 may determine the priority of a first-type control (e.g., P control or Proportional control) and a second-type control (e.g., I control or Integral control) according to the output error, and determine or estimate an intermediate voltage value or a final voltage value by varying a gain value of P control and I control. P control may refer to a method of control in proportion to a difference between the control amount and a target value (e.g., adjusting voltage output in response to deviations between the control amount and a target value). I control may refer to a control method of integrating the difference between the control amount and the target value over time, and increasing the operating amount when this accumulated value reaches a specific value to eliminate a deviation, thereby approaching the target value more precisely (e.g., making one or more adjustments at the specific value to approach the target value more precisely). For example, in conditions where rapid changes in power demand occur (e.g., sudden acceleration), P control may be prioritized, whereas in stable cruising conditions, I control may play a greater role in fine-tuning long-term stability. In order to prevent excessive accumulation of the voltage adjustment amount according to feedback control, a gain value that varies according to an output error may be used as a gain value of feedback control. Each of a first-gain value (e.g., P-gain value) for the first-type control (e.g., P control or Proportional control) and a second-gain value (e.g., I-gain value) for the second-type control (e.g., I control or Integral control) may be selected based on (or to correspond to) a variable output error through a predefined dataset (e.g., a pre-stored table). The voltage correction unit 470 may increase the P-gain value in response to a large output error to enhance control responsiveness and increase the I-gain value in case of small output error to increase output stability, while simultaneously reducing or minimizing unnecessary accumulation of the voltage adjustment amount of feedback control (e.g., preventing control overshoot). In at least some implementations, the first-type control may be P control in a proportional integral (PI) control, and the second-type control may be an integral (I) control in PI control.

When the fuel cell 100 is operated, a voltage at the same output may have variations according to the driving conditions of the vehicle and the state of the fuel cell 100, and the voltage adjustment amount is increased according to the feedback control to follow the variations (e.g., the changed voltage). According to the example of the present disclosure, when the voltage adjustment amount exceeds a certain amount (e.g., a preset threshold value) during the feedback control, the processor 400 may reflect the voltage adjustment amount in the corrected voltage value to reduce or minimize accumulation (e.g., an excessive accumulation) of the voltage adjustment amount, and accordingly, stable voltage control of the fuel cell 100 may be performed.

According to an example of the present disclosure, the voltage control of the fuel cell 100 may be enhanced or optimized by applying an adjustment (e.g., a correction factor) for considering the driving conditions of the vehicle and the state of the fuel cell 100 to the initial voltage value. Further, the voltage control of the fuel cell 100 may be enhanced or optimized by reflecting a part of the accumulated amount of the voltage adjustment amount according to feedback control and I control in the corrected voltage value to which the correction factor is applied.

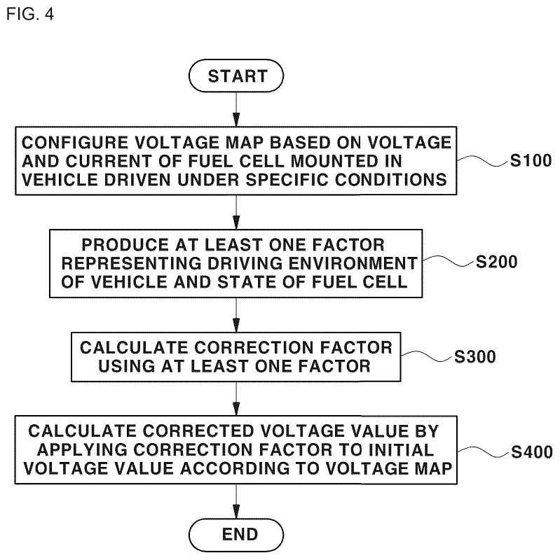

FIG. 4 shows an example of a flowchart for describing a method of calculating a correction factor according to an example of the present disclosure.

Referring to FIGS. 2 and 4, the processor 400 may configure a voltage map based on the voltage and current of the fuel cell 100 mounted in the vehicle operating under specific conditions. For example, the voltage map may include reference values for various power demands (e.g., idle, acceleration, cruising) and environmental conditions (e.g., high altitude, extreme temperatures). That is, the voltage map may store the voltage for each output of the fuel cell 100. The processor 400 may determine the initial voltage value of the fuel cell 100 based on requested output of the driver and the voltage map (S100).

The processor 400 may produce at least one factor representing the driving environment of the vehicle and the state of the fuel cell 100. The factor representing the driving environment of the vehicle may include parameters such as the operation duration of the fuel cell 100, the outside temperature, and the atmospheric pressure. For example, additional parameters may include road conditions (e.g., smooth highways vs. steep inclines), humidity levels, and wind resistance, which may affect the energy demands of the vehicle. The factors representing the state of the fuel cell 100 may include the coolant temperature of the fuel cell 100, the SR of air supplied to the cathode of the fuel cell 100, and the relative humidity of the fuel cell 100 (S200). These factors may be used for dynamically adjusting the voltage to ensure stable fuel cell operation and prevent degradation over time.

The processor 400 may determine an adjustment (e.g., a correction factor) using at least one factor. The processor 400 may determine the correction factor by considering at least one of the coolant temperature, the outside temperature, the atmospheric pressure, the SR, or the relative humidity. Specifically, the processor 400 may determine the correction factor by considering (e.g., comparing) the current coolant temperature relative to the target coolant temperature, a value obtained by subtracting the reference temperature from the current outside temperature and dividing the resultant value by 273, considering (e.g., comparing) the current atmospheric pressure relative to the target atmospheric pressure, considering (e.g., comparing) the current SR relative to the target SR, and considering (e.g., comparing) the current relative humidity relative to the target relative humidity (S300).

The processor 400 may calculate a corrected voltage value by applying the correction factor to the initial voltage value according to the voltage map. Specifically, the processor 400 may determine or estimate the corrected voltage value by multiplying a value obtained by subtracting a voltage drop amount (e.g., (caused by prolonged operation or environmental conditions) according to the operation duration of the fuel cell 100 from the initial voltage value and multiplying a resultant value by the correction factor. For example, if the voltage drop is caused by thermal cycling over a long-distance travel (e.g., fuel cell aging), environmental effects, or operational conditions, the correction factor may compensate by fine-tuning the applied voltage, ensuring a consistent power output. The processor 400 may determine an adjusted voltage value by accounting for the voltage drop. That is, the processor 400 may determine or estimate the corrected voltage value using a value obtained by subtracting the voltage drop amount from the initial voltage value in order to account for lowered performance of the fuel cell 100 due to deterioration of the fuel cell 100 according to operation duration of the fuel cell 100. This process may allow real-time enhancement or optimization of power output without requiring additional hardware modifications. The corrected voltage value may be a value continuously updated when the driving environment of the vehicle and the state of the fuel cell 100 are changed (S400), ensuring that fuel cell efficiency is maintained under varying operation conditions of the vehicle.

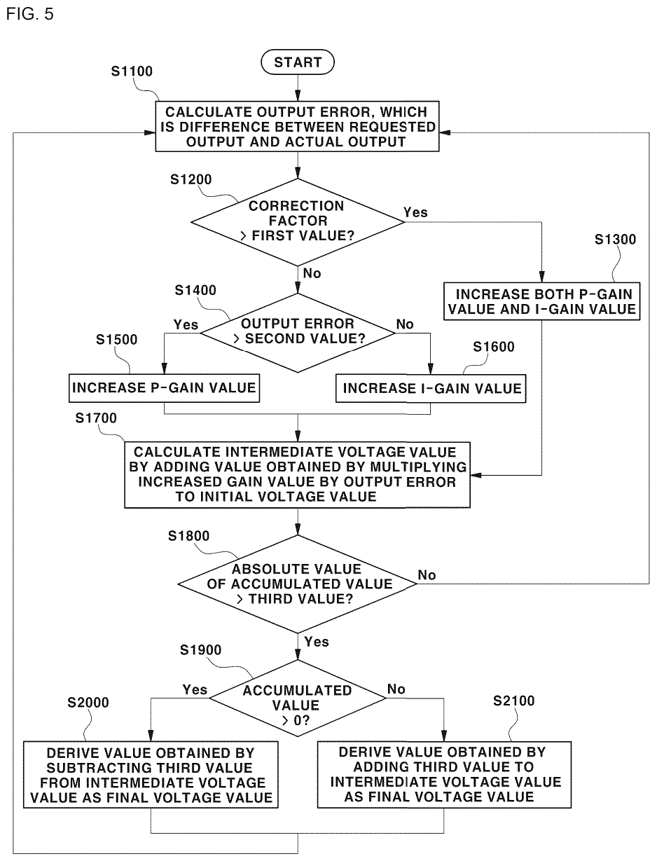

FIG. 5 shows an example of a flowchart for describing a method of calculating a final voltage value for voltage control of the fuel cell according to an example of the present disclosure.

Referring to FIG. 2 and FIG. 5, the processor 400 may determine an output discrepancy (e.g., an output error), which is a difference between the requested output and the actual output. The actual output may be determined by a corrected voltage value obtained by applying an adjustment (e.g., a correction factor) to an initial voltage value. The correction factor may be derived by matching the requested output with the pre-stored voltage map (S1100) (e.g., dynamically selected based on the pre-stored voltage map and real-time operating conditions of the vehicle).

The processor 400 may compare the correction factor with a first value. For example, the first value may be a predetermined constant. For example, this first value may serve as a threshold to determine whether voltage adjustments require basic corrections or more complex control mechanisms. For example, if the correction factor is greater than the first value, this may indicate that a difference between the initial voltage value and the corrected voltage value is large enough such that P control and I control are simultaneously required during feedback control (S1200).

If the correction factor is greater than the first value, the processor 400 may increase each of the P-gain value for P control and the I-gain value for I control by a preset value. For example, the P-gain value may be increased to enhance immediate response, while the I-gain value may be adjusted to ensure long-term stability. For example, the preset value may be 0.01, but may be changed or modified based on system requirements or a designer specification (e.g., a designer (S1300)).

The processor 400 may determine or estimate an intermediate voltage value by adding each of values obtained by multiplying each of the increased P-gain value and I-gain value by the output error to the corrected voltage value.

$$Intermediate voltage value = Corrected voltage value + {A}_{i} \times {P}_{Gn ( i )} + {\sum }_{i = 1}^{n} {A}_{i} \times {I}_{Gn ( i )}$$

In this instance, Aᵢ denotes the output error, P_{Gn(i)} denotes the P-gain value, and I_{Gn(i)} denotes the I-gain value (S1700).

If the correction factor is less than or equal to the first value, the processor 400 may compare the output error with a second value, which is determined by the requested output and control the gain value according to either P control or I control. The second value may be a value obtained by multiplying the requested output by a preset first error value. The first error value may be determined by measurement uncertainty of a current sensor and a voltage sensor of the fuel cell 100 (e.g., an error of the current sensor and an error of the voltage sensor). For example, adjustments may be made based on sensor precision, ensuring that minor variations do not trigger unnecessary voltage changes. For example, the first error value may be 0.03, but may be changed by the designer (S1400).

The processor 400 may increase the P-gain value for P control (e.g., allowing a faster response to deviations in the fuel cell voltage) by a preset value if the output error is greater than the second value (S1500).

The processor 400 may increase the I-gain value for I control (e.g., compensating for gradual changes such as long-term fuel cell degradation) by a preset value if the output error is less than or equal to the second value (S1600).

The processor 400 may determine or estimate the intermediate voltage value by adding each of values obtained by multiplying each of the increased P-gain value and I-gain value by the output error to the corrected voltage value. In this instance, a voltage correction amount according to I control may be accumulated to the intermediate voltage value. This ensures that long-term deviations are addressed while preventing abrupt fluctuations. The processor 400 may repeatedly determine the intermediate voltage value by incorporating the output error through P control or I control until an accumulated value (e.g., by I control) reaches a predefined limit (S1700). Specifically, the processor 400 may repeat a process of determining an intermediate voltage value by adding a value obtained by multiplying the output error by the P-gain value or a value obtained by multiplying the output error by the I-gain value to the corrected voltage value until an absolute value of an accumulated value obtained by multiplying the output error by the I-gain value becomes greater than a third value obtained by multiplying a voltage drop amount according to the operation duration of the fuel cell 100 by a preset second error value. The third value may be a reference value of an accumulated value of I control accumulated by the continuous operation of the fuel cell 100. For example, the preset second error value may be 1.02, but may be changed by the designer (S1700).

The processor 400 may compare the absolute value of the accumulated correction value with the third value. The accumulated value may be a positive or negative number. If the absolute value of the accumulated value is greater than the third value, it may indicate that a voltage compensation amount by I control is excessive. For example, excessive accumulation may lead to overcorrection, resulting in instability in power delivery. As the operating time of the fuel cell 100 increases, the accumulated amount according to I control may increase due to reversible deterioration of the fuel cell 100, and when the accumulated amount becomes excessive, a branching phenomenon in the V-I performance curve may occur. The accumulated amount according to I control may be reduced or minimized by changing the I-gain value according to the magnitude of the output error. However, when the accumulated amount of I control exceeds a certain amount, this may indicate that reversible deterioration of the fuel cell 100 or output followability of the fuel cell 100 has deteriorated (e.g., failing to accurately track output variations), and thus voltage branching and voltage drop phenomena may be prevented by controlling the accumulated amount by reflecting the accumulated amount in the voltage itself. If the absolute value of the accumulated correction value is equal to or less than the third value, the processor 400 may determine or estimate the intermediate voltage value to update the output error and apply adjusted P control and/or I control according to the updated output error. When the output error is updated, the corrected voltage value may be replaced with a last derived intermediate voltage value. That is, the corrected voltage value in the above formula may be a last calculated intermediate voltage value (S1800).

If the absolute value of the accumulated value is greater than the third value, the processor 400 may determine the final voltage value by applying the third value or the absolute value of the accumulated value to the intermediate voltage value. Specifically, if the accumulated value is a positive value, the processor 400 may determine the final voltage value by subtracting the third value or the absolute value of the accumulated value from the intermediate voltage value, and if the accumulated value is a negative value, the processor 400 may determine the final voltage value by adding the third value or the absolute value of the accumulated value to the intermediate voltage value. Preferably, the processor 400 may determine the final voltage value by adding or subtracting the third value to or from the intermediate voltage value. After the final voltage value is derived, the processor 400 may update an output discrepancy (e.g., an output error), which is a difference between the requested output and the actual output. The processor 400 may repeatedly perform a process of deriving the intermediate voltage value and deriving the final voltage value based on the updated output error (S1900, S2000, and S2100).

According to an example of the present disclosure, in a feedback control process including P control and I control, when an accumulated value according to I control is excessive, branching of a voltage performance curve and a voltage drop phenomenon may be prevented by adjusting (e.g., subtracting or adding) a value corresponding to the accumulated value from or to the intermediate voltage value.

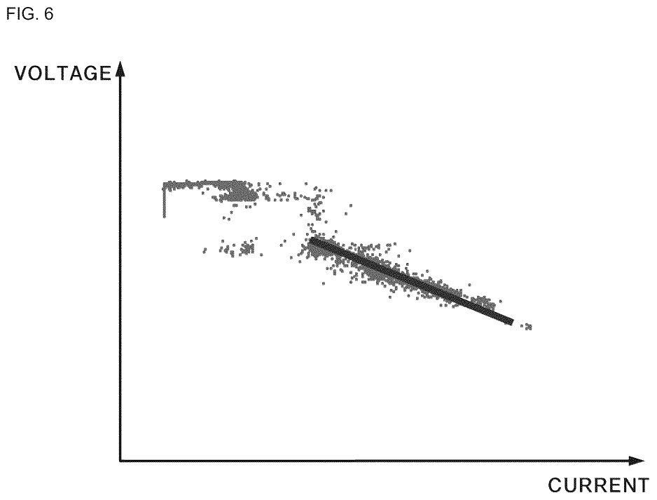

FIG. 6 shows an example of a graph for describing following one V-I performance curve when controlling a voltage of the fuel cell according to an example of the present disclosure.

Referring to FIGS. 2 and 6, the processor 400 may perform feedback control using an output discrepancy (e.g., an output error), which is a difference between the actual output of the fuel cell 100 and the requested output, to operate the fuel cell 100 at an appropriate or desired potential, thereby determining a final voltage value. The processor 400 may control voltage of the fuel cell 100 so as to follow a substantially ideal V-I curve by controlling the converter 200 based on the intermediate voltage value or the final voltage value determined as a result of feedback control. For example, when the vehicle transitions between different power loads—such as accelerating, cruising, or regenerative braking—the processor 400 may dynamically adjust the voltage to maintain efficiency and prolong fuel cell lifespan. When the accumulated amount of I control during feedback control exceeds a certain amount (e.g., a preset threshold), undesirable behaviors such as branching of the V-I curve or a voltage drop phenomenon may occur. The branching of the V-I curve may refer to a scenario where multiple voltage values correspond to the same current, leading to instability in fuel cell performance. The voltage drop phenomenon, on the other hand, may reduce power output efficiency and negatively impact overall system reliability. According to an example of the present disclosure, when the accumulated value generated by I control exceeds the preset threshold, the voltage branching and voltage drop phenomenon may be prevented by applying the accumulated value or a value corresponding to the accumulated value to the final voltage value that is ultimately derived. This approach may stabilize the fuel cell's voltage characteristics, ensuring consistent energy output while reducing the risk of performance degradation over time.

A technical challenge of the present disclosure is to provide a system and method for controlling a voltage of a fuel cell capable of performing optimized voltage control of the fuel cell in consideration of a driving environment of a vehicle and a state of the fuel cell.

Another technical challenge of the present disclosure is to provide a system and method for controlling a voltage of a fuel cell capable of improving fuel cell stability and reliability of voltage control by reflecting deterioration of the fuel cell and a voltage adjustment amount formed during operation in voltage control of the fuel cell.

In one example, the present disclosure provides a system for controlling a voltage of a fuel cell. In a system for controlling a voltage of a fuel cell including a processor configured to control the voltage of the fuel cell based on a driving environment of a vehicle and a state of the fuel cell, the processor calculates a correction factor for performing correction on an initial voltage value of the fuel cell, and calculates a voltage value for controlling the fuel cell by performing feedback control using an output error between actual output and requested output on a corrected voltage value obtained by applying the correction factor to the initial voltage value.

In a preferred example, the driving environment of the vehicle may include at least one of operation duration of the fuel cell, an outside temperature, or an atmospheric pressure, and the state of the fuel cell may include at least one of a coolant temperature of the fuel cell, a stoichiometric ratio (SR) of air supplied to a cathode of the fuel cell, or relative humidity of the fuel cell.

In another preferred example, the correction factor may be calculated based on at least one of an outside temperature, an atmospheric pressure, the coolant temperature of the fuel cell, the SR, or the relative humidity of the fuel cell, and the corrected voltage value may be calculated by multiplying a value obtained by subtracting a voltage drop amount according to the operation duration of the fuel cell from the initial voltage value by the correction factor.

In still another preferred example, the initial voltage value may be derived by a voltage map that stores voltage values measured according to a plurality of requested outputs required for the fuel cell when the vehicle is driven.

In yet another preferred example, when the correction factor is greater than a first value, the processor may increase each of a P-gain value for P control and an I-gain value for I control, and calculate an intermediate voltage value by adding a value obtained by multiplying each of the increased P-gain value and I-gain value by the output error to the corrected voltage value.

In still yet another preferred example, when the correction factor is less than or equal to a preset first value, the processor may compare the output error with a second value determined by the requested output and control a gain value according to any one of P control or I control.

In a further preferred example, the processor may increase a P-gain value for P control when the output error is greater than the second value obtained by multiplying the requested output by a preset first error value, and increase an I-gain value for I control when the output error is less than or equal to the second value.

In another further preferred example, the processor may calculate an intermediate voltage value by adding a value obtained by multiplying the output error by the P-gain value or a value obtained by multiplying the output error by the I-gain value to the corrected voltage value until an absolute value of an accumulated value obtained by multiplying the output error by the I-gain value becomes greater than a third value obtained by multiplying a voltage drop amount according to operation duration of the fuel cell by a preset second error value.

In still another further preferred example, when the absolute value of the accumulated value is greater than the third value, the processor may calculate a final voltage value by applying the third value to the intermediate voltage value.

In yet another further preferred example, when the accumulated value is a positive value, the processor may calculate the final voltage value by subtracting the third value from the intermediate voltage value, and when the accumulated value is a negative value, the processor may calculate the final voltage value by adding the third value to the intermediate voltage value.

In still yet another further preferred example, the processor may calculate an intermediate voltage value by simultaneously performing P control and I control on the corrected voltage value or sequentially performing P control and I control on the corrected voltage value based on a result of comparing the correction factor with a preset first value.

In a still further preferred example, when an absolute value of an accumulated value accumulated in the corrected voltage value according to I control is greater than a third value, the processor may calculate a final voltage value by adding or subtracting an absolute value of the accumulated value or the third value to or from the intermediate voltage value updated according to P control and I control.

In another example, the present disclosure provides a method of controlling a voltage of a fuel cell. A method of controlling a voltage of a fuel cell includes calculating, by a processor, a correction factor for performing correction on an initial voltage value of the fuel cell by considering at least one factor representing a driving environment of a vehicle and a state of the fuel cell, and deriving, by the processor, a voltage value for controlling the fuel cell by applying a result of performing feedback control using an output error between actual output and requested output on a corrected voltage value obtained by multiplying the correction factor by the initial voltage value.

In a preferred example, the initial voltage value of the fuel cell may be derived by a voltage map that stores voltage values measured according to a plurality of requested outputs required for the fuel cell when the vehicle is driven.

In another preferred example, the driving environment of the vehicle may include at least one of operation duration of the fuel cell, an outside temperature, or an atmospheric pressure, the state of the fuel cell may include at least one of a coolant temperature of the fuel cell, an SR of air supplied to a cathode of the fuel cell, or relative humidity of the fuel cell, and the calculating a correction factor may include calculating the correction factor by considering at least one of an outside temperature, an atmospheric pressure, the coolant temperature of the fuel cell, the SR, or the relative humidity of the fuel cell in a value obtained by subtracting a voltage drop amount according to the operation duration of the fuel cell from the initial voltage value.

In still another preferred example, the deriving a voltage value may include comparing the correction factor with a preset first value, calculating an intermediate voltage value by simultaneously performing P control and I control on the corrected voltage value or sequentially performing P control and I control on the corrected voltage value based on a result of comparing the correction factor with a preset first value, and calculating a final voltage value by adding or subtracting a third value to or from the intermediate voltage value updated according to P control and I control when an absolute value of an accumulated value accumulated in the intermediate voltage value according to I control is greater than the third value.

In yet another preferred example, when the correction factor is greater than the preset first value, the intermediate voltage value may be calculated by adding a value obtained by multiplying each of a P-gain value for P control and an I-gain value for I control by the output error to the corrected voltage value.

In still yet another preferred example, when the correction factor is less than or equal to the first value, the intermediate voltage value may be calculated by comparing the output error with a second value determined by the requested output and applying a gain value increased according to any one of P control or I control to the corrected voltage value.

In a further preferred example, the calculating an intermediate voltage value may be performed until an absolute value of the accumulated value obtained by multiplying the output error by an I-gain value for I control becomes greater than the third value obtained by multiplying a voltage drop amount according to operation duration of the fuel cell by a preset second error value.

In another further preferred example, the deriving a voltage value may include calculating the final voltage value by subtracting an absolute value of the accumulated value or the third value from the intermediate voltage value when the accumulated value is a positive value, and calculating the final voltage value by adding the absolute value of the accumulated value or the third value to the intermediate voltage value when the accumulated value is a negative value.

According to an example of the present disclosure, the fuel cell voltage control system may induce an appropriate potential of the fuel cell and minimize additional fuel cell deterioration factors by utilizing a corrected voltage value obtained by applying a correction factor to an initial voltage value when controlling the voltage of the fuel cell. By applying the correction factor to the initial voltage value, it becomes possible to control the voltage of the fuel cell reflecting the driving environment of the vehicle and the state of the fuel cell.

According to an example of the present disclosure, when the voltage adjustment amount exceeds a certain amount during feedback control, the processor may reflect the voltage adjustment amount in the corrected voltage value to minimize accumulation of the voltage adjustment amount, and thus stable voltage control of the fuel cell may be performed.

According to an example of the present disclosure, optimized voltage control of the fuel cell may be implemented by applying a correction factor for reflecting a driving condition of the vehicle and a state of the fuel cell to an initial voltage value, and reflecting a part of an accumulated amount of a voltage adjustment amount according to feedback control and I control in an initial voltage value to which a correction factor is applied.

According to an example of the present disclosure, in a feedback control process including P control and I control, when an accumulated value according to I control is excessive, branching of a voltage performance curve and a voltage drop phenomenon may be prevented by subtracting or adding a value corresponding to the accumulated value from or to an intermediate voltage value.

Even though the examples of the present disclosure have been described above with reference to the attached drawings, those skilled in the art to which the present disclosure pertains will understand that the present disclosure may be implemented in other specific forms without changing the technical idea or essential characteristics thereof. Therefore, it should be understood that the examples described above are illustrative in all respects and not restrictive.

What is claimed:

1. A system of a vehicle, the system comprising:
memory storing at least one instruction; and
a processor configured to execute the at least one instruction and cause the system to:
control, based on an operating environment of the vehicle and a state of a fuel cell, a voltage of the fuel cell,
wherein the processor is configured to control the voltage of the fuel cell by:
determining a correction factor for performing correction on an initial voltage value of the fuel cell, and
calculating a voltage value for controlling the fuel cell by performing feedback control, wherein the feedback control adjusts the corrected voltage value using an output error, the output error being a difference between an actual output and a requested output.

2. The system of claim 1, wherein:
the operating environment of the vehicle comprises at least one of operation duration of the fuel cell, an outside temperature, or an atmospheric pressure, and
the state of the fuel cell comprises at least one of a coolant temperature of the fuel cell, a stoichiometric ratio (SR) of air supplied to a cathode of the fuel cell, or relative humidity of the fuel cell, wherein the SR of air corresponds to a ratio of an actual amount of air supplied to the cathode relative to a minimum amount of air required for the fuel cell.

3. The system of claim 2, wherein:
the correction factor is determined based on at least one of the outside temperature, an atmospheric pressure, the coolant temperature of the fuel cell, the SR, or the relative humidity of the fuel cell, and
the corrected voltage value is determined as a product of a value and the correction factor, wherein the value is obtained by subtracting a voltage drop amount, according to the operation duration of the fuel cell, from the initial voltage value.

4. The system of claim 3, wherein the initial voltage value is derived by a voltage map, wherein the voltage map is configured to store voltage values measured according to a plurality of requested outputs, and wherein the plurality of requested outputs are required for the fuel cell for driving the vehicle.

5. The system of claim 1, wherein, when the correction factor is greater than a first value, the processor is configured to:
increase a first-gain value for a first-type control and increase a second-gain value for a second-type control, and
determine an intermediate voltage value by based on a sum of the corrected voltage value, a first product of the increased first-gain value and the output error, and a second product of the increased second-gain value and the output error.

6. The system of claim 1, wherein, when the correction factor is less than or equal to a preset first value, the processor is configured to:
compare the output error with a second value determined by the requested output, and
control, based on one of a first type control or a second type control, a gain value.

7. The system of claim 6, wherein the processor is configured to:
increase, based on the output error being greater than the second value, a first-gain value for the first type control, wherein the second value is obtained by multiplying the requested output by a preset first error value, and
increase, based on the output error being less than or equal to the second value, a second-gain value for the second type control.

8. The system of claim 1, wherein the processor is configured to determine an intermediate voltage value by iteratively adjusting the corrected voltage value, wherein each iteration comprises determining a voltage adjustment amount based on a product of the output error and either a first-gain value for a first type control or a second-gain value for a second type control, and adding the voltage adjustment amount to an accumulated value, wherein the iterations continue until an absolute value of the accumulated value, accumulated over one or more iterations, exceeds a third value, wherein the third value is obtained by multiplying a voltage drop amount, according to an operation duration of the fuel cell, by a preset second error value.

9. The system of claim 8, wherein, based on the absolute value of the accumulated value exceeding the third value, the processor is configured to determine a final voltage value by applying the third value to the intermediate voltage value.

10. The system of claim 9, wherein:
based on the accumulated value being a positive value, the processor is configured to determine the final voltage value by subtracting the third value from the intermediate voltage value, and
based on the accumulated value being a negative value, the processor is configured to determine the final voltage value by adding the third value to the intermediate voltage value.

11. The system of claim 1, wherein the processor is configured to determine an intermediate voltage value by, based on a result of comparing the correction factor with a preset first value:
simultaneously performing a first type control and a second type control on the corrected voltage value, or
sequentially performing the first type control and the second type control on the corrected voltage value.

12. The system of claim 11, wherein, based on an absolute value of an accumulated value, accumulated by updating the corrected voltage value according to the second type control, exceeding a third value, the processor is configured to determine a final voltage value by modifying the intermediate voltage value, wherein the intermediate voltage value is updated based on the first type control and the second type control, and wherein the intermediate voltage value is modified by subtracting or adding the absolute value of the accumulated value or the third value from or to the intermediate voltage value.

13. A method performed by a processor of a vehicle, the method comprising:
determining, based on an operating environment of the vehicle and a state of a fuel cell of the vehicle, a correction factor for performing correction on an initial voltage value of the fuel cell;
obtaining a product of the correction factor and the initial voltage value as a corrected voltage value;
deriving a voltage value for controlling the fuel cell by performing feedback control, wherein the feedback control adjusts the corrected voltage value using an output error, wherein the output error is a difference between an actual output and a requested output; and
controlling, based on the derived voltage value, an operation of the fuel cell.

14. The method according to claim 13, wherein the initial voltage value of the fuel cell is derived by a voltage map, wherein the voltage map is configured to store voltage values measured according to a plurality of requested outputs, and wherein the plurality of requested outputs are required for the fuel cell for driving the vehicle.

15. The method according to claim 13, wherein:
the operating environment of the vehicle comprises at least one of operation duration of the fuel cell, an outside temperature, or an atmospheric pressure,
the state of the fuel cell comprises at least one of a coolant temperature of the fuel cell, an SR of air supplied to a cathode of the fuel cell, or relative humidity of the fuel cell, and
the determining the correction factor comprises determining the correction factor based on at least one of the outside temperature, the atmospheric pressure, the coolant temperature of the fuel cell, the SR of air, or the relative humidity of the fuel cell, wherein the corrected voltage value is determined as a product of a value and the correction factor, wherein the value is obtained by subtracting a voltage drop amount, according to the operation duration of the fuel cell, from the initial voltage value.

16. The method according to claim 13, wherein the deriving the voltage value comprises:
comparing the correction factor with a preset first value;
determining an intermediate voltage value by, based on the comparing, simultaneously performing a first type control and a second type control on the corrected voltage value or sequentially performing the first type control and the second type control on the corrected voltage value; and
determining, based on an absolute value of an accumulated value exceeding a third value, a final voltage value by modifying the intermediate voltage value, wherein the intermediate voltage value is updated according to the first type control and the second type control, wherein the accumulated value is accumulated in the intermediate voltage value based on the second type control, and wherein the intermediate voltage value is modified by adding or subtracting the third value to or from the intermediate voltage value.

17. The method according to claim 16, wherein, based on the correction factor exceeding the preset first value, the intermediate voltage value is determined based on a sum of the corrected voltage value, a first product of a first-gain value for the first type control and the output error, and a second product of a second-gain value for the second type control and the output error.

18. The method according to claim 16, wherein, based on the correction factor being less than or equal to the preset first value, the intermediate voltage value is determined by:
comparing the output error with a second value determined by the requested output, and
applying a gain value to the corrected voltage value, wherein the gain value is increased based on one of the first type control or the second type control.

19. The method according to claim 18, wherein the determining the intermediate voltage value is iteratively performed until an absolute value of the accumulated value, accumulated over one or more iterations, exceeds the third value, wherein the accumulated value is obtained by multiplying the output error by a second-gain value for the second type control, and wherein the third value is obtained by multiplying a voltage drop amount, according to an operation duration of the fuel cell, by a preset second error value.

20. An apparatus comprising:
memory storing at least one instruction; and
a processor configured to execute the at least one instruction and cause the apparatus to:
control, based on an operating environment of a fuel cell and a state of the fuel cell, a voltage of the fuel cell,
wherein the processor is configured to control the voltage of the fuel cell by:
determining a correction factor for performing correction on an initial voltage value of the fuel cell, and
calculating a voltage value for controlling the fuel cell by performing feedback control, wherein the feedback control adjusts the corrected voltage value using an output error, the output error being a difference between an actual output and a requested output.
